(19) United States
(12) Patent Application Publication
(10) Pub. No.: US 2022/0142755 A1
(43) Pub. Date: May 12, 2022

(54) Round Dental Blank Holder And Arrangement Having A Holder And A Round Dental Blank

(71) Applicant: Ivoclar Vivadent AG, Schaan (LI)

(72) Inventors: Markus Lichtensteiger, Montlingen (CH); Martin Bertagnolli, Naturns (IT)

(21) Appl. No.: 17/519,636

(22) Filed: Nov. 5, 2021

(30) Foreign Application Priority Data
Nov. 6, 2020 (EP) 20206313.7

(51) Int. Cl. A61C 13/00; A61C 5/77

(52) U.S. Cl. CPC A61C 13/0022; A61C 5/77

(57) ABSTRACT

The invention relates to a round dental blank holder (10), in particular with a holding undercut. The holder (10) consists of two parts (12, 14), which in particular are semi-circular and can be connected to each other or mounted on each other, which are intended to surround a round dental blank (16), thereby fixing it, and/or to mount it without play, in particular to fix it in a non-positive and/or form-fitting manner.

### CROSS-REFERENCE TO RELATED APPLICATIONS

This application claims priority to European Patent Application No. 20206313.7 filed on Nov. 6, 2020, the disclosure of which is incorporated herein by reference in its entirety.

### TECHNICAL FIELD

The invention relates to a round dental blank holder and an arrangement having a holder and round dental blank.

### BACKGROUND

Round dental blank holders of this type and their individual parts, i.e. the holder and the round dental blank, have been known for a long time. An example of this is the solution known from DE 44 36 231 A1. The round dental blank in the case of that solution is comparatively small in terms of diameter and has a distinctly wide edge. This edge is held in a clamped manner in a milling holder.

The round dental blank according to the named document is more suitable for individual teeth, as FIG. 5 thereof shows.

In subsequent years, discs have become established, having a diameter of around 10 cm and consisting of a millable material and being intended to receive a plurality of dental restoration parts.

These are typically disposed in the most space-saving manner possible on the round dental blank which acts as a milling blank. The arrangement is first produced virtually, i.e. in advance. Then the milling blank is clamped in a milling holder, and the milling machine, which is intended to mill out the dental restoration parts, begins its work.

For milling which meets high precision requirements, the dental restoration parts must be provided clearly spaced apart from each other while leaving holding webs.

This means that it is attempted to optimise the arrangement of the dental restoration parts but also to make good use of the round dental blanks or milling blanks by going as close to the edge as possible.

The selection of the material for the milling blank to be used is linked to this. Blanks consisting of ZrO₂ can easily cost around €500.

On the other hand, it is necessary to ensure sufficient stability for mounting of the round dental blanks. Although the desire is to waste as little “milling space” as possible in mounting, the mounting must still naturally be extremely stable since milling forces of several 100 N are required.

Owing to the necessity to make the most efficient use possible of the expensive blank material there have been attempts to produce the most stable possible milling holder, e.g. according to DE 20 2010 001 125 U1.

A further improved solution is found in DE 20 2013 103 515 U1. In the case of that solution, the milling holder grips a protruding edge formed on the blank.

If necessary, a smaller blank can also be used, which is correspondingly more favourable.

Furthermore, from DE 10 2015 204 174 A1 and corresponding US 20170065381, which is hereby incorporated by reference, a holding device for a dental blank is known in which a synthetic material ring is used to fasten the dental blank or the round dental blank. The fixing element in that case should have setting elements which are intended for clamping purposes.

Such setting elements can be set screws, threaded pins, cams or cam levers.

That solution has not become established. The problem is the practical implementation and the complexity, including in conjunction with the milling holders used.

U.S. Pat. No. 7,604,759, 20170333168 and 20180055612 are directed to mill blanks and are herein incorporated by reference in their entirety.

### SUMMARY

In contrast, it is the object of the invention to produce a round dental blank holder and an arrangement consisting of a holder and a round dental blank according to the claims, which solve the problem of fixing the round dental blank in the holder better and in a material-saving manner with respect to the round dental blank material, without disadvantages arising in handling and costs.

In accordance with the invention, this object is achieved by the claims. Advantageous developments are apparent from the dependent claims.

In accordance with the invention, a particular embodiment of the holder is provided. “Milling holder” is to be understood as the clamping device of the milling machine for receiving the round dental blank, while the holder in accordance with the invention is fundamentally fixed to the round dental blank throughout its service life and is thrown away together with the milled remains of the round dental blank which are no longer required.

In accordance with the invention, provision is made for the holder to consist of at least two parts complementing each other to form a circle. The two or more parts span the round dental blank and are connected to each other at their respective ends. The first part is connected at its first end to the first end of the second part, and the first part is connected with its second end at the second end of the second part.

It is also possible for the parts to be fixed to each other at one point and to be connected to each other via a joint or hinge, in particular a film hinge, at the opposite point. By this embodiment, the holder is able to unfold, so to speak, and, by snapping-in of a latch connection, the round dental blank can be fixed therein.

The assembly effort is less.

The latch or snap-in connection preferably takes place under the realization of tensile stresses. The tension leads to tension existing in the circumferential direction in the parts which complement each other to form a circle, which tension accordingly acts radially inwardly and places the round dental blank under pressure in the radially inward direction.

However, it is also possible for the parts of the holder merely to surround the round dental blank during assembly, possibly with an air gap of between 0.1 and 0.5 mm which also serves to compensate for tolerances.

This solution is preferred if the actual mounting takes place in a second step using adhesive.

The use of an expandable adhesive such as polyurethane reactive (PUR) adhesive is also possible; in such a case, an air gap of e.g. 0.2 mm, but also between 0.1 mm and 0.5 mm, is preferably left in front of the adhesive, this gap being filled by the adhesive upon expansion.

The pressure generated by the expansion produces an overpressure in the—narrow—gap between the holder and round blank, which results in particularly good pressure of the adhesive against the adjoining surfaces of the round blank and holder.

An integrally bonded connection can also be produced when the round dental blank is fabricated of a plastic such as polymethyl methacrylate (PMMA). For this purpose, the outer circumference of the round blank is partially melted by the adhesive.

In an advantageous embodiment, the parts are connected to each other via snap-fit or latch connections which are suitable for exerting tensile stresses.

In a further advantageous embodiment, provision is made for the parts of the holder also to be connected in a material bonding or an integrally joined manner via the frictional or non-positive connection as explained above. This can happen, e.g. by an inserted double-sided adhesive tape, by ultrasound, by laser welding or even by any other bonding process. A force-locking or non-positive and integrally joined (material-locking) composite can thus be produced.

Any non-positive mount or connection may be used to mount the dental blank to said two parts. Said mount may be a force-fit mount, a force actuated mount or a frictional mount or connection, or any mount which is achieved by a force acting on said two parts to press them against said blank, and, by this, to obtain a firm and fixed connection therebetween.

When the parts of the holder are also C-shaped in cross-section so that they can overlap the round dental blank at its upper side and at its lower side, a form-fitting connection can also be produced, i.e. all three possible types of connection at the same time, so to speak.

Instead of the C shape, viewed in the cross-section of the holder, an L shape is also possible. However, with this solution the upper end limb is absent, but the lower end limb them serves both as a stop and as a mounting aid which sets the vertical position of the round blank in advance.

Surprisingly, the dividing of the holder in the circumferential direction and the fitting together of the parts to provide the holder for the round dental blank, results in the solution in accordance with the invention in a savings on the expensive material of the round dental blank.

The round blanks can be held and machined with comparatively little application of force. The material costs for the holder in accordance with the invention can be e.g. €1, i.e. less than the material costs of the round dental blank by more than two orders of magnitude.

Unexpectedly, the arrangement in accordance with the invention, consisting of a round dental blank and holder, is particularly suitable for use in the available milling holders or clamping devices of milling machines. The snap-in latching function at the ends of the parts can readily be integrated into the course of the holder, i.e. without a recess having to be produced on the milling holder to accommodate the latching devices.

For this purpose, latching devices which are known per se can be produced, having latching tongues and latching projections. Any type of latching devices may be used. Another example of such latching devices are click-stop devices. The latching device provides the snap-in latching function between the two parts, i.e., between the ends thereof. Such devices include devices which offer a form-fit when said ends are brought into close contact with each other. A latching tongue as a “male” part at the end of the first part may be inserted into a latching recess as a “female” part. The “male” part comprises an engagement hook while the “female” part comprises an undercut. These both are spring biased towards each other such that they snap towards each other when the “male” part is fully inserted into the “female” part, and thus form a form-fit connection.

The holder in accordance with the invention also does not impair the ability to make the fullest possible use of the round dental blank. The edge space, i.e. the usable part of the milling blank to be milled or of the round dental blank to be milled can even be reduced slightly. This is owing to the fact that the milling blank typically consists of a material to be sintered. This is highly resistant to pressure but less resistant to tension. By means of the stress or tension which the holder in accordance with the invention exerts radially inwardly, the force vectors which are exerted during milling are shifted towards pressure, so that the load-bearing capacity of the dental blank due to milling forces increase.

In accordance with the invention, it is particularly favourable for the parts to be formed as half-shells which form the holder when clipped together and onto each other. The two half-shells or the plurality of parts are latched onto each other in a first assembly step, for which purpose they each have suitable latching devices at the ends.

Even in this state, the two half-shells as the holder exert a pressure on the round dental blank.

In a second step, the two half-shells as the holder are non-releasably fixed on the round dental blank. This can be effected by means of ultrasound, laser welding or even by means of an adhesive process.

In an advantageous embodiment of the invention, provision is made for the end limb or the end limbs of the holder to have at least one inclined surface with which the round dental blank can be placed under pre-stressing or pretension between the end limbs.

The two half-shells can be made of synthetic or plastic material, wherein it is also possible to form the radially inner region in the form of a more elastic or softer plastic or synthetic material layer and the radially outer region from a harder plastic or synthetic material.

The two half-shells may be made from any suitable material. Examples, include, but not limited to materials for the two half-shells are a material with a hardness of more than 50 Shore-D and more preferably of more than 80 Shore-D, or even 90 Shore-D or more. Examples include, but are not limited to, ABS, PMMA, PA or the like. Ranges include 50-80, 50-90 or 50-100 or more Shore-D.

The softer material has a hardness lower than the hardness of the above half-shells. The softer material that may form the radially inner region is more flexible than the harder material and the hard material has a higher hardness on the durometer scale than the softer material. The softer material or component may have a “soft,” “medium soft,” or “medium hard” durometer scale value as measured on the Shore Hardness Scale. The hard material or component or the two half-shells may have a durometer scale value that is “medium hard”, “hard” or “extra hard” on the Shore Hardness Scale.

Examples, include, but not limited to materials for the softer component are a synthetic material with rubber-elastic properties, such as a thermoplastic elastomer, in particular one with a Shore A hardness in the range of 30 to 70. The soft material may be a material in the hardness range of 12 Shore-A to 80 Shore-D, and preferably between 16 Shore-A and 50 Shore-A. Further examples include, but are not limited to, SEBS, or, e.g. a foamed PUR with a hardness between 20 Shore-A and 40 Shore-A.

The soft and hard components may also be referred to herein as two components having different hardness values, the harder material has a first hardness value and the softer material has a second hardness value, the first hardness value is higher than the second hardness value. The hard component refers to the component with the first hardness value that is higher than the hardness of the second hardness value, i.e., the softer component.

The layer thickness of the softer material may be between 0.1 mm and 1 mm, preferably between 0.2 mm and 0.5 mm. A lower layer thickness allows a lower hardness without any unwanted displacement of the softer material.

In an advantageous embodiment of the invention, provision is made for the round dental blank holder to have at least two components, the harder one of which overlaps the softer one. In a further advantageous embodiment of the invention, provision is made for the radially inwardly facing surface of the holder to be formed by and on the softer component.

The non-releasable or non-detachable fixing allows the round dental blanks to be held and machined with less application of force.

Mounting in the milling holder can be effected by a form-fitting profile of the holder, and the holder can overlap the round dental blank, i.e. lie against both its upper side and also its lower side and therefore form a C-shaped profile in cross-section.

The round dental blanks can be fabricated of any suitable materials, e.g. including ZrO₂, PMMA, titanium, Co—Cr and other suitable materials, which require removal of material by subtractive machining.

It is preferred that a round dental blank holder is provided having at least two parts which are configured to surround and/or to mount to a round dental blank in a non-positive, integrally bonded and/or form-fitting manner.

It is preferred that an arrangement is provided having a holder and a round dental blank, the holder includes at least two parts, the at least two parts are semi-circular and configured for mounting to each other, the at least two parts surround the round dental blank and/or mount to the round dental blank in a non-positive, integrally bonded and/or form-fitting manner.

It is preferred that the at least two parts are configured to be fixed to each other or to be fixed to each other at one point and connected to each other at the opposite point via a film hinge, and in a state in which they are fixed to each other, comprise an inner diameter between 95 mm and 102 mm.

It is preferred that the at least two parts each have latching devices at ends thereof, by which latching devices the at least two parts are configured to be latched to one another, and the holder is formed such that upon snapping-in of the latching devices, the holder spans and fixes the round dental blank in a non-positive manner under pre-stressing or pretension.

It is preferred that the holder is fabricated of synthetic material or has a synthetic material that is formed on an inner circumference of the holder such that the holder is fastened to the round dental blank by welding, shrinking and/or adhesion.

It is preferred that the at least two parts include an end limb that extends radially inwardly on the upper side of the round dental blank and/or the lower side of the at least two parts of the holder, with which end limb or with which end limbs a round dental blank is mounted in a form-fitting manner, and/or the at least two parts of the holder have a C shaped profile or an L shaped profile in cross-section, which L shaped profile comprises an inner side that acts as a stop and mounting aid for the round blank.

It is preferred that at least one corner recess is formed on the inner side of the C-shaped or L-shaped profile of the transition between the end limb or the end limbs of the holder and a middle limb of the holder.

It is preferred that the end limb(s) are fabricated of synthetic material which is millable, and remaining regions of the end limb or of the end limbs mount to the round dental blank in a form-fitting manner.

It is preferred that each part is formed as a half-shell which has a semi-cylindrical surface on a radially inwardly facing side, which surface receives a double-sided adhesive tape by which the round dental blank is adhered into the holder.

It is preferred that the at least two parts are formed symmetrically with respect to each other and/or complement each other to form a circular ring.

It is preferred that at least one form-fitting profile for mounting the holder in or on a milling holder is formed radially on the outside of the holder, and/or radially on the outside, the holder comprises, as a holding projection, at least partially circumferentially, a form-fitting profile having an undercut.

It is preferred that at least two parts consists of two parts, which are semi-circular and configured to mount or connect to each other.

It is preferred that radially inwardly of the holder, and/or radially inwardly of an end limb of the holder, a cover extends which covers the inner space of the holder and a round dental blank is received therein.

It is preferred that the cover is articulated on one of the parts, and/or the cover is connected in an integrally bonded manner to the holder, with a component that is softer in hardness than the hardness of the holder, and the connecting line between the cover and the holder forms a desired breaking point, and/or the cover is provided with a tear-off strip which can unfold.

It is preferred that in the pre-assembly of the round dental blank and the holder, an air gap is formed between the round dental blank and the holder in a thickness of between 0.1 mm and 0.5 mm, and adjacent to the air gap, an expandable adhesive is introduced, upon expansion of which the round dental blank can be fixed in the holder. It is preferred that the expandable adhesive comprises PUR.

### BRIEF DESCRIPTION OF THE DRAWINGS

Further advantages, details and features of the invention will be apparent from the following description of several exemplified embodiments of the invention with reference to the drawings.

In the drawings:

FIG. 1 shows a round dental blank holder and a round dental blank before being fitted together, in one embodiment of the invention;

FIG. 2 shows the combination of round dental blank holder and round dental blank when fitted together;

FIG. 3 shows a perspective view of a half-shell or of a part of the holder in accordance with the invention in one embodiment;

FIG. 4 shows a further embodiment of a round dental blank holder in accordance with the invention with a round dental blank inserted;

FIG. 5 shows a detail of a further embodiment of a round dental blank holder;

FIG. 6 shows a perspective view of a round dental blank holder with a round dental blank inserted;

FIG. 7 shows a schematic perspective sectional view of an embodiment of a round dental blank in accordance with the invention with the integrated round dental blank holder;

FIG. 8 shows a schematic sectional view to clarify a modification of the embodiment according to FIG. 5 or according to FIG. 7 to illustrate the form-fitting profile;

FIG. 9 shows a modification of the illustration according to FIG. 8;

FIG. 10 shows a further modification of the illustration according to FIGS. 8 and 9;

FIG. 11 shows a modified illustration of a round dental blank holder with the provision of alternative form-fitting profiles;

FIG. 12 shows a schematic selective illustration of an embodiment of a milling holder, of the round dental blank holder and of a round dental blank changer;

FIG. 13 shows a sectional view of the embodiment according to FIG. 12;

FIG. 14 shows a modified embodiment of the illustration according to FIG. 12; and

FIG. 15 shows a modified embodiment of the invention, shown in part.

### DETAILED DESCRIPTION

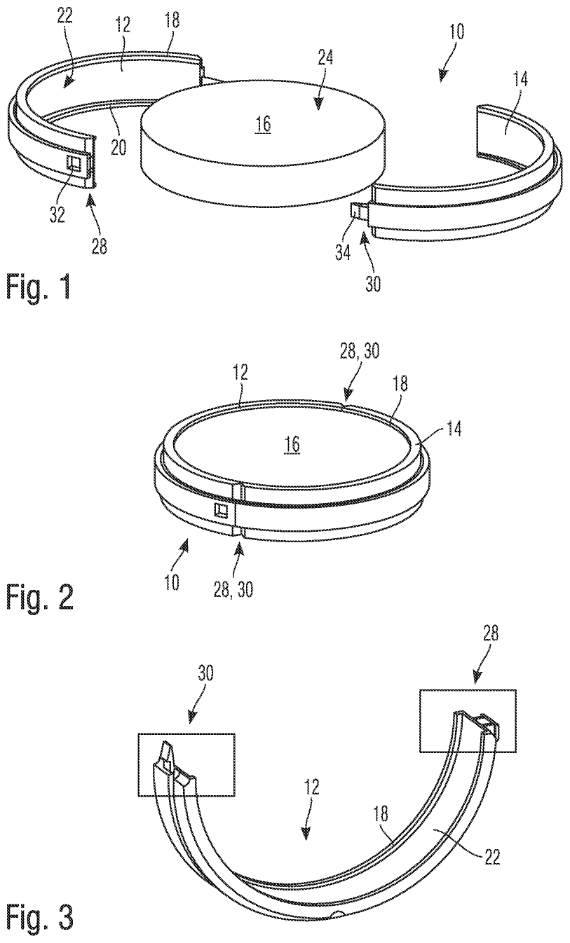

FIG. 1 shows a round dental blank holder 10 in an exploded perspective view. The round dental blank holder 10 consists of a first part or of a first half-shell 12 and of a second part or of a second half-shell 14. Each half-shell 12 or 14 is substantially semicircular and is intended to surround a round dental blank 16. The round dental blank 16 is formed in a manner which is known per se as a flat-cylindrical body, consisting of e.g. ZrO₂ and having a diameter of about 100 mm.

The round dental blank holder 10 has substantially the same inner diameter as the outer diameter of the round dental blank 16. As seen in cross-section, the profile of the holder 10 is substantially C-shaped, i.e. with an upper end leg or limb 18, a lower end leg or limb 20 and a middle leg or limb 22.

The height of the middle limb 22 corresponds to the height of the round dental blank 16. Therefore, the upper end limb 18 lies on top of the round dental blank 16, and the lower end limb 20 lies against the bottom of the round dental blank 16. In this respect, the holder 10 overlaps the round dental blank 16 on all sides.

The surface of the upper side 24 of the round dental blank 16 is somewhat reduced by this overlapping or radially inwardly directed projection dimension of the holder 10. However, this does not detract from the suitability for milling because the material of the holder 10 is synthetic material and therefore also millable.

The two half-shells 12 and 14 each have latching devices at the ends, a female latching device 28 and a male latching device 30 of which are shown in FIG. 1. The latching device 28 comprises a latching recess 32 and the latching device 30 comprises a latching tongue 34. The latching tongue 34 is intended to latch to an undercut of the latching recess 32. It will be understood that any other latching system is possible without departing from the scope of the invention.

FIG. 2 shows the state in which the holder 10 overlaps the round dental blank 16 and in which the latching devices 28 and 30, and the corresponding latching devices opposite them, are latched to each other. In this state, the round dental blank 16 is under pressure because the holder 10 exerts a pretension or pre-stress on the round dental blank 16.

In the illustrated exemplified embodiment, a double-sided adhesive tape is inserted in the middle limb or center leg 22. By the effect of the pre-stressing, pressure is exerted against this tape and the round dental blank 16 is firmly fixed in the holder 10.

In a modified embodiment, instead of the double-sided adhesive tape, a thermosetting or hot-curing adhesive or an adhesive which cures in visible light is applied. In both cases it is favourable for the material of the holder 10 is made of transparent plastic or synthetic material which is transparent in visible light. The supplied radiation, whether light radiation or heat radiation, cures the adhesive and firmly connects the round dental blank 16 thereto.

In a still further embodiment, an elastic soft layer is attached to the inside of the holder 10. This is particularly suitable for exerting the desired pretension and passing it on to the round dental blank 16.

In an alternative embodiment, one of the latching devices 28, 30 is replaced by a hinge or joint. The two parts 12 and 14 are connected to each other by the hinge so as to pivot about a vertical axis.

In this embodiment, it is possible to produce the two parts together as one piece, e.g. by injection moulding. In addition, the assembly of the round blank 16 in the holder 10 is simplified because, for assembly purposes, the parts 12, 14 can simply be pivoted away from each other or be splayed. By pivoting together and latching at the latching device 28, 30 opposite the hinge, the round blank 16 is already clamped and mounted in the holder 10.

FIG. 3 shows a half-shell 12 in another perspective view. It can be seen that the end limbs 18 and 20 protrude a little radially inwardly, e.g. by 2 mm. This projection dimension is still sufficient to ensure the desired fixing.

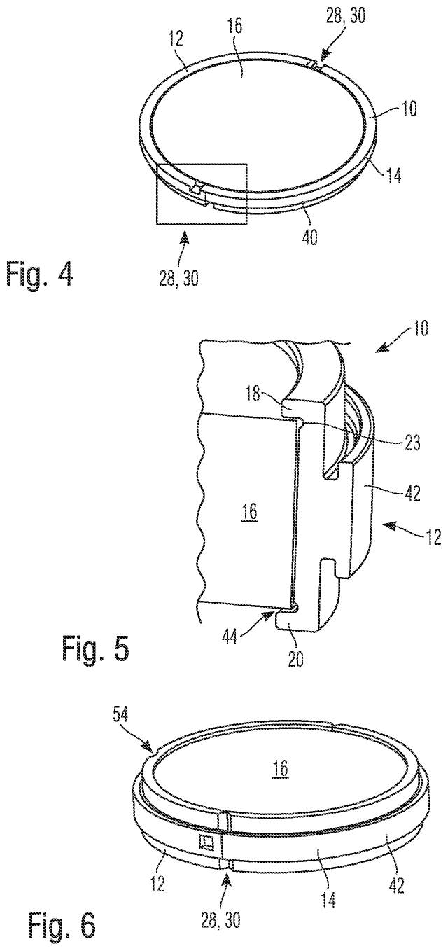

A further embodiment of a round dental blank 16 in accordance with the invention and of a round dental blank holder 10 in accordance with the invention is shown in FIG. 4. The latching devices 28 and 30 illustrated therein have differently formed latching tongues 34 and latching recesses 32. In the radially outwards direction, the holder 10 comprises a protruding ring 40 which is overlapped by the milling holder 48, not visible in FIG. 4, and thereby fixes the round dental blank 16.

FIG. 5 shows a modified embodiment of a holder 10 in accordance with the invention. This solution differs from the solution according to the embodiments of FIGS. 1 to 4 by an undercut profile 42 which is attached radially on the outside and is intended for engagement of the milling holder at this location. The profile of the holder 10 when considered in the radially inwards direction is again substantially C-shaped, and the holder 10 overlaps the round blank 12 with the upper end limb 18 and the lower end limb 20. The two end limbs 18 and 20 are connected to each other by the middle limb 22.

They rest without play and/or firmly on the round dental blank 16, under pretension if possible.

The transitions of the end limbs 18 and 20 to the middle limb 22 have a corner recess 23 on the inside, which preferably has a small radius. This can also extend around the corner edge of the round dental blank 16, thus exposing it. The inner radius extends at the transition of the end limb 18 to the middle limb 22 and of the end limb 20 to the middle limb 22. It also serves as a protective edge for the radially outer edge of the e.g. ceramic, round dental blank 16, which is sensitive to fracture.

In a modified embodiment, the round dental blank 16 is slightly oversized with respect to the distance between the end limb 18 and the end limb 20. This oversize makes it possible, for assembly and tolerance compensation, to press the holder 20 in the form of the associated half-shell 12 onto the round dental blank 16. For this purpose, each end limb 20 has an insertion bevel or slope 44 at the end. The insertion slop 44 facilitates the insertion of the round dental blank 16 into the C-shaped profile of the half-shell 12.

In the illustrated exemplified embodiment, a dovetail profile is provided as the undercut profile 42. It will be understood that any other undercut is possible without departing from the scope of the invention.

FIG. 6 shows that the holder 10 has a notch 54 which is adjacent to the upper end limb 18. The notch 54 serves to secure against rotation and corresponds to a corresponding probe or a projection on the milling machine, which engages into the notch 54.

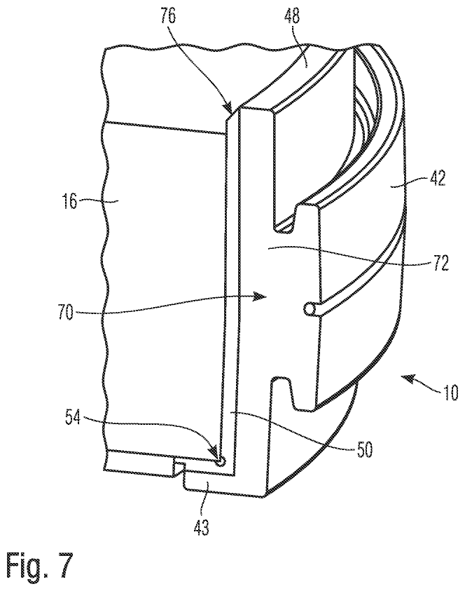

FIG. 7 shows a further embodiment of the invention with an L-shaped profile 70 of the holder 10 in a sectional view. The profile 70 consists of a vertical limb 72 on which the form-fitting profile 42 is formed as a unitary construction in the radially outwards direction, and of a horizontal limb 43 issuing therefrom at the bottom, extending radially inwardly and corresponding to the lower end limb of the C-shaped profile.

At the transition between these limbs 72 and 43, a groove 54 is provided on the inside which completely exposes a fracture edge of an inserted ceramic round dental blank 16.

The L-shaped profile 72 consisting of a harder component 48 is fully lined on the inside with a softer component 50.

Since the L-shaped profile 72 is open at the top it is possible to insert a round dental blank 16 into the holder 10 from there. In order to facilitate insertion, the inner, softer component 48 has an insertion slope 76. Furthermore, the holder 10 extends upwards beyond the round dental blank 16 and so it is received therein in a safely protected manner.

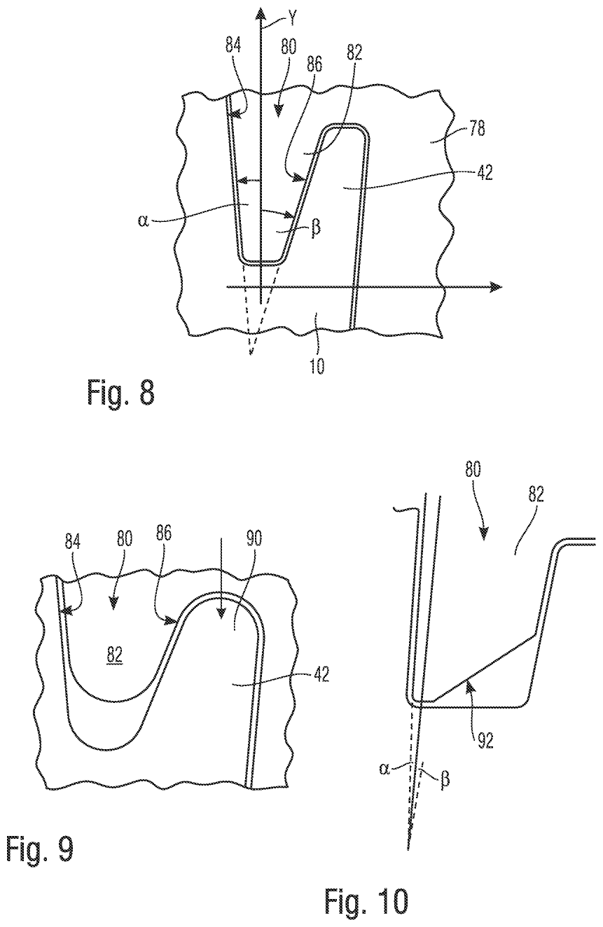

FIG. 8 shows a sectional view of a round dental blank holder 10 which is engaged with a partially illustrated milling holder 78. The mounting of the holder 10 in the milling holder 78 is effected via an undercut profile 42, a dovetail profile in the illustrated exemplified embodiment.

The following explanations also serve to illustrate that numerous desired embodiments of a form-fitting profile are possible without departing from the scope of the invention.

In a manner which is known per se, the form-fitting profile has a groove 80 into which a web 82 of the milling holder 78 engages.

FIG. 8 shows the upper part of the dovetail profile 42 and of the milling holder 78 and it is understood that the lower part has mirror symmetry to this.

The groove 80 has a groove flank 84 on the round blank side and a groove flank 86 on the milling holder side.

Furthermore, a movement axis Y of the milling holder 78 is indicated in FIG. 8, along which the two milling holder halves, i.e. the upper one illustrated in this case and the lower one, can travel or move.

As shown in FIG. 8, there is an angle α between the axis Y and the groove flank 84 on the round blank side and an angle ß between the axis Y and opposite the groove flank 86 on the milling holder side.

This angle can be adapted in wide ranges to suit the requirements. The angle α can be e.g. 1° to 8° and is 5° in the case of the example.

In contrast, the angle ß is preferably greater, specifically between 1° and 45°, preferably between 5° and 20° and in the illustrated exemplified embodiment is 15°.

Larger angles have the advantage that tolerances can be accommodated better while smaller angles lead to better fixing with lower holding forces.

In this case, an adaptation to the requirements can be made within wide ranges.

According to FIG. 8, the web 82 extends into the groove 80 in such a way that the groove is completely, or almost completely, filled. However, this is not necessarily required, as shown, inter alia, by FIGS. 9 and 10 and the fundamental considerations. Since the undercut profile 42 likewise extends with an upper part and a lower part, and the two parts of the milling holder 78 are moved towards each other in order to provide the form-fit, the vertical setting of height is achieved by the contact at the end 90 of the profile 42 via the horizontal surface at that location.

For the transmission of the milling forces it is important to provide support against moments which act around the contact point or contact line, the two-part design of the milling holder 78 and therefore of the form-fitting profile, and the long load arm thus produced, lead to a favourable effect and in the upper part considered here only a part of the forces need to be absorbed.

For the torque sensing of moments (moment of absorption), the large-surface contact between the web 82 and the groove flank 84 on the round blank side, but also the groove flank 86 on the milling holder side, is required. However, this does not have to take place over the entire height of the groove 80 and so it is sufficient for the web 82 to extend into the groove 80 only in the upper part. The leverage effect is best at this point.

A modified embodiment with respect thereto is shown in FIG. 10. The web 82 also does not extend fully into the groove 80 in this case so as to fill it completely but rather an insertion slope 92 is formed at the lower/radially outer point of the web 82. In this exemplified embodiment, the angles α and ß are, in addition, substantially smaller, specifically α=2° and ß=4°.

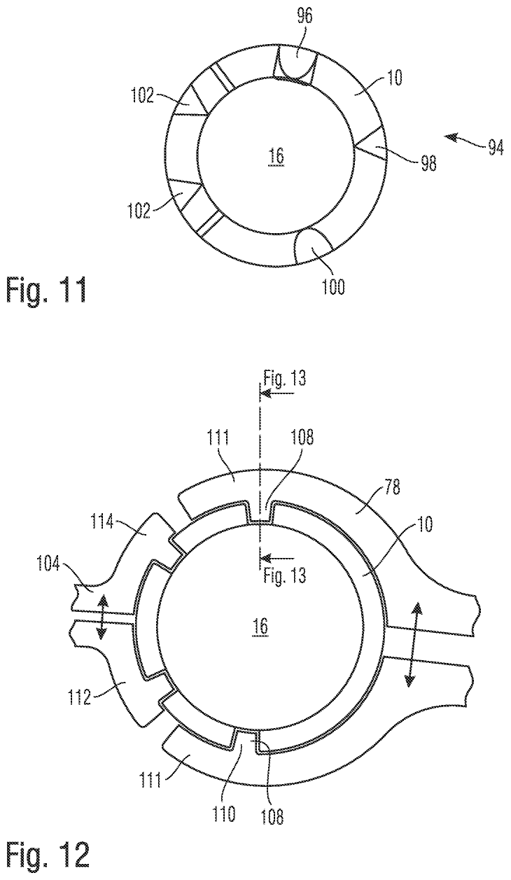

FIG. 11 schematically illustrates a further embodiment in accordance with the invention of a round dental blank holder 10. In this embodiment, the holder 10 is provided with form-fitting recesses 94 in regions. These can be distributed non-uniformly around the holder 10 and be the same as each other or can have forms which differ from each other.

Merely by way of example, a cuboidal recess 96, a conical recess 98 and a semispherical recess 100 are illustrated in this case. Instead of the conical recess 98, a triangular recess can also be produced and other desired shapes are possible.

In the illustrated exemplified embodiment, the form-fitting profiles described herein extend through an angle of less than 360°, e.g. through 240°. They are intended to receive corresponding suitably shaped spigots of the milling holder 78.

The milling holder 78 can, with this solution, preferably be divided not in the horizontal direction but in the vertical direction. Furthermore, the region of the holder 10 on the left in the illustration of FIG. 11 is provided with recesses 102 which are intended for engagement with a changer of a workpiece magazine.

In order for the machined round dental blank 12 to be changed, a changer suitable for this purpose grasps the holder 10 at the recesses 102, and the milling holder 78 releases the round dental blank 16 with the holder 10 in machined form. The changer removes the round blank 16 from the milling region and presents to the milling holder 78, a new round blank 16 which is to be machined.

In the illustrated exemplified embodiment, the gripping region of the changer extends over considerably less than 180°, e.g. over or equal to 120°.

A further embodiment of such a milling holder 78 in cooperation with a changer 104 is shown in FIG. 12. In that case, two trapezoidal recesses 108 are provided at different and mutually asymmetrical angular positions of the holder 10. Corresponding spigots 110 of the milling holder 78 engage therein.

As shown, the milling holder 78 in this case is also divided with a vertical separation plane. Both tines 111 of the milling holder 78 overlap the round dental blank 12 with its holder 10 by about 230°, and the changer 104, which also has two tines 112 and 114 with a vertical separation plane, has a wrap angle of about 120° with respect to the holder 10.

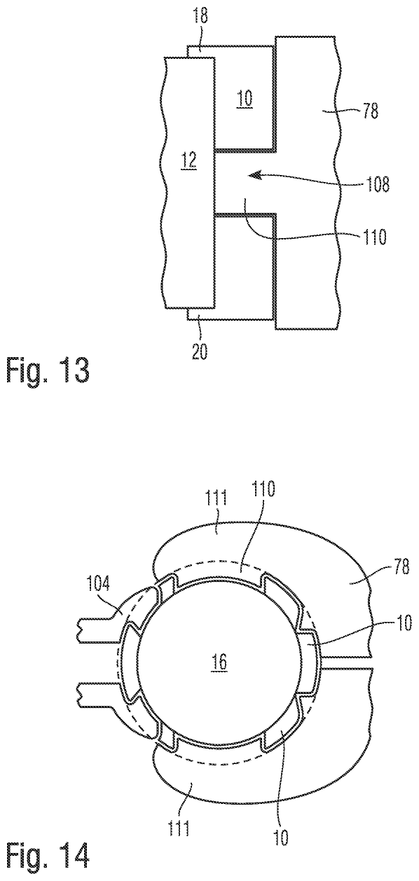

A section through a detail of FIG. 12 is shown in FIG. 13. As shown, the recess 108 extends merely over the middle part of the height of the holder 10. The spigot 110 fills this recess. Therefore, the desired form-fit is ensured.

As shown, the holder 10 is also C-shaped in cross-section in this embodiment and so it overlaps the round blank 12 with its end limbs 18 and 20.

A further embodiment of a round dental blank holder 10 in accordance with the invention with an associated milling holder 78 is shown in FIG. 14. The same reference numerals in this and also in the other figures refer to the same parts, and this holder 10 is also intended for the production of a changer 104 for a milling machine with a workpiece magazine.

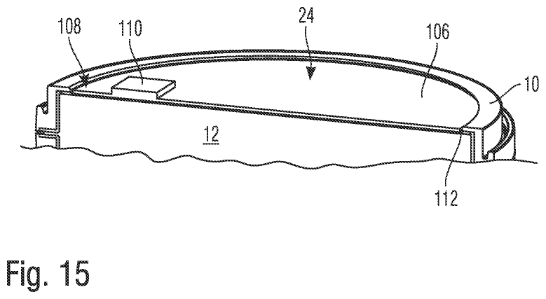

FIG. 15 shows another embodiment of the invention. Provision is made for a cover 106 for the round dental blank 12 which cover 106 is to be articulated on the holder 10 and to extend over the exposed disc surface of the round dental blank 12. The cover 106 can be connected to the holding ring by a film hinge 112 and can also cover the whole upper side 24 of the round dental blank 12.

The cover 106 can also be provided in the same way on the lower side of the round dental blank so that the two covers together with the holding ring form a package for the round dental blank 12.

The cover 106 can also be designed in such a way that a region of the transition between the cover 106 and the holding ring is formed as a hinge 112, while the remaining region can be split so that the cover 106 can be unfolded at the hinge formed in this way.

FIG. 15 shows the manner in which the cover 106 can extend over the upper side 24 of the round dental blank 12. In the illustrated exemplified embodiment, the cover 106 has a tear-off strip 110 which for its part can unfold and is for this purpose connected to the cover 106 via a film hinge.

When the tear-off strip 110 is pulled, the cover 106 separates from the holder 10 at a connecting line 108 via the softer component which is thin at that location. In this respect, this connecting line 108 forms a desired breaking point which permits easy removal of the cover 106.

The terms “about” and “substantially” are intended to include the degree of error or uncertainty associated with measurement of the particular quantity or shape as one of ordinary skill in the art would understand.

1. A round dental blank holder comprising
at least two parts (12, 14) which are configured to surround and/or to mount to a round dental blank (16) in a non-positive, integrally bonded and/or form-fitting manner.

2. An arrangement comprising
a holder and
a round dental blank,
wherein the holder (10) comprises at least two parts (12, 14), the at least two parts are semi-circular and configured for mounting to each other, the at least two parts surround the round dental blank (16) and/or mount to the round dental blank in a non-positive, integrally bonded and/or form-fitting manner.

3. The round dental blank holder as claimed in claim 1,
wherein the at least two parts (12, 14) are configured to be fixed to each other or to be fixed to each other at one point and connected to each other at the opposite point via a film hinge, and in a state in which they are fixed to each other, comprise an inner diameter between 95 mm and 102 mm.

4. The round dental blank holder as claimed in claim 1,
wherein the at least two parts (12, 14) each have latching devices (28, 30) at ends thereof, by which latching devices (28, 30) the at least two parts (12, 14) are configured to be latched to one another, and
wherein the holder (10) is formed such that upon snapping-in of the latching devices (28, 30), the holder spans and fixes the round dental blank (16) in a non-positive manner under pre-stressing or pretension.

5. The round dental blank holder as claimed in claim 1,
wherein the holder (10) is fabricated of synthetic material or comprises synthetic material that is formed on an inner circumference of the holder such that the holder is fastened to the round dental blank (16) by welding, shrinking and/or adhesion.

6. The round dental blank holder as claimed in claim 1,
wherein the at least two parts (12, 14) comprise an end limb (18, 20) that extends radially inwardly on the upper side (24) of the round dental blank and/or
wherein the lower side of the at least two parts (12, 14) of the holder (10), with which end limb (18, 20) or with which end limbs (18, 20), a round dental blank (16) is mounted in a form-fitting manner, and/or
wherein the at least two parts (12, 14) of the holder (10) have a C-shaped profile or an L-shaped profile in cross-section, which L shaped profile comprises an inner side that acts as a stop and mounting aid for the round blank (16).

7. The round dental blank holder as claimed in claim 6,
wherein at least one corner recess (23) is formed on the inner side of the C-shaped or L-shaped profile of the transition between the end limb (18, 20) or the end limbs (18, 20) of the holder (10) and a middle limb (22) of the holder (10).

8. The round dental blank holder as claimed in claim 6,
wherein the end limb(s) (18, 20) are fabricated of synthetic material which is millable, and
wherein remaining regions of the end limb (18, 20) or of the end limbs (18, 20) mount to the round dental blank (16) in a form-fitting manner.

9. The round dental blank holder as claimed in claim 1,
wherein each part (12, 14) is formed as a half-shell (12, 14) which has a semicylindrical surface on a radially inwardly facing side, which surface receives a double-sided adhesive tape by which the round dental blank (16) is adhered into the holder (10).

10. The round dental blank holder as claimed in claim 1,
wherein the at least two parts (12, 14) are formed symmetrically with respect to each other and/or complement each other to form a circular ring.

11. The round dental blank holder as claimed in claim 1,
wherein at least one form-fitting profile for mounting the holder (10) in or on a milling holder is formed radially on the outside of the holder (10), and/or
wherein, radially on the outside, the holder (10) comprises, as a holding projection, at least partially circumferentially, a form-fitting profile having an undercut (42).

12. The round dental blank holder as claimed in claim 1,
wherein at least two parts consists of two parts (12, 14), which are semi-circular and configured to mount or connect to each other.

13. The round dental blank holder as claimed in claim 1,
wherein, radially inwardly of the holder (10), and/or radially inwardly of an end limb (18, 20) of the holder (10), a cover (106) extends which covers the inner space of the holder (10) and a round dental blank (16) is received therein.

14. The round dental blank holder as claimed in claim 13,
wherein the cover is articulated on one of the parts (12, 14), and/or
wherein the cover is connected in an integrally bonded manner to the holder (10), with a component that is softer in hardness than the hardness of the holder (10), and the connecting line (108) between the cover (104) and the holder (10) forms a desired breaking point, and/or
wherein the cover (106) is provided with a tear-off strip (110) which is configured for unfolding.

15. The round dental blank holder as claimed in claim 1,
wherein, in the pre-assembly of the round dental blank (16) and the holder (10), an air gap is formed between the round dental blank (16) and the holder (10) in a thickness of between 0.1 mm and 0.5 mm, and
wherein, adjacent to the air gap, an expandable adhesive is introduced, upon expansion of which the round dental blank (16) is fixed in the holder.

16. The round dental blank holder as claimed in claim 15,
wherein the expandable adhesive comprises PUR.
